(19) United States
(12) Patent Application Publication
(10) Pub. No.: US 2026/0074212 A1
(43) Pub. Date: Mar. 12, 2026

(54) LITHIUM AND MANGANESE RICH POSITIVE ACTIVE MATERIAL COMPOSITIONS

(71) Applicant: FORD GLOBAL TECHNOLOGIES, LLC, Dearborn, MI (US)

(72) Inventors: Eunsung LEE, Novi, MI (US); Chi PAIK, Grosse Ile, MI (US); Robert KUDLA, Canton, MI (US); Jason LUPESCU, Wayne, MI (US); Yisun CHENG, Ann Arbor, MI (US)

(21) Appl. No.: 18/830,175

(22) Filed: Sep. 10, 2024

(51) Int. Cl. H01M 4/525; H01M 4/02; H01M 4/131; H01M 4/36; H01M 4/505; H01M 4/62; H01M 10/0525; H01M 10/0568; H01M 10/0569; H01M 10/44

(52) U.S. Cl. CPC H01M 4/525; H01M 4/131; H01M 4/366; H01M 4/505; H01M 4/621; H01M 4/625; H01M 10/0525; H01M 10/0568; H01M 10/0569; H01M 10/44; H01M 2004/027; H01M 2004/028

(57) ABSTRACT

A positive electrode active material for lithium-ion batteries may include a compound represented by the general formula Li_{1.10-a}Mn_{0.52+a}Ni_{0.38-x}CoₓO₂ wherein 0<a<0.1, 0≤x≤0.02, an average oxidation state of the Ni is 2.0, and an average oxidation state of the Mn is between 3.6 and 4.0.

### TECHNICAL FIELD

In at least one aspect, positive electrode active materials for lithium-ion batteries are provided.

### BACKGROUND

Lithium and Manganese Rich (LMR) positive electrode active material has been considered a promising next-generation cathode material due to its high gravimetric energy density compared to currently used Nickel Cobalt Manganese (NCM) and Nickel Cobalt Aluminum (NCA) materials.

### SUMMARY

In at least one aspect of the disclosure, a positive electrode active material for lithium-ion batteries is provided. This active material includes a compound represented by the general formula Li_{1.10-a}Mn_{0.52+a}Ni_{0.38-x}CoₓO₂, wherein 0<a<0.1, 0≤x≤0.02, an average oxidation state of the Ni is 2.0, and an average oxidation state of the Mn is between 3.6 and 4.0. The positive electrode active material may have a layered crystal structure, specifically an α-NaFeO₂-type structure. The active material may be included in a cathode.

In another aspect of the disclosure, a positive electrode for a lithium-ion battery is provided. This electrode includes a positive electrode active material with a compound represented by the chemical formula Li_{1.10-a}Mn_{0.52+a}Ni_{0.38-x}CoₓO₂, wherein 0<a<0.1, 0≤x≤0.02, an average oxidation state of the Ni is 2.0, and the average oxidation state of the Mn is between 3.6 and 4.0. The positive electrode may include a conductive additive, such as carbon black, graphite, or carbon nanotubes, and a binder, such as polyvinylidene fluoride or carboxymethyl cellulose. The material may have a specific capacity of at least 180 mAh/g.

In yet another aspect of the disclosure, a rechargeable lithium-ion battery with at least one lithium-ion battery cell is presented. Each lithium-ion battery cell includes a positive electrode with a positive electrode active material represented by the chemical formula Li_{1.10-a}Mn_{0.52+a}Ni_{0.38-x}CoₓO₂, wherein 0<a<0.1, 0≤x≤0.02, an average oxidation state of the Ni is 2.0, and an average oxidation state of the Mn is between 3.6 and 4.0. The battery may include a negative electrode, which may include a negative active material such as graphite, silicon, or a silicon-carbon composite, and an electrolyte comprising a lithium salt and an organic solvent. The lithium salt may be selected from lithium hexafluorophosphate, lithium tetrafluoroborate, lithium perchlorate, lithium hexafluoroarsenate, lithium bis(trifluoromethanesulfonyl)imide, lithium bis(fluorosulfonyl)imide, or combinations thereof.

### BRIEF DESCRIPTION OF THE DRAWINGS

FIG. 1A is a schematic view, in cross-section, of a positive electrode that includes cathode active material on a single side of a current collector;

FIG. 1B is a schematic view, in cross-section, of a positive electrode that includes cathode active material on both sides of a current collector;

FIG. 2 is a schematic view, in cross-section, of a battery cell that includes the positive electrode of FIG. 1A; and

FIG. 3 is a schematic view, in cross-section, of a battery pack that includes the battery cells of FIG. 2.

### DETAILED DESCRIPTION

The currently preferred compositions, embodiments, and methods of the present disclosure, which represent the best-known practices to the inventors, are described. The figures provided are not necessarily to scale. The disclosed embodiments are merely examples, and the disclosure can be embodied in various alternative forms. Consequently, the specific details provided should not be seen as limiting. Instead, they serve as a representative basis for understanding any aspect of the disclosure and as guidance for those skilled in the art on how to apply the present disclosure in various ways.

Unless expressly stated otherwise, when a given chemical structure includes a substituent on a chemical moiety (e.g., on an aryl, alkyl, etc.), that substituent is assumed to apply to a more general chemical structure encompassing the given structure. Percentages, “parts of,” and ratio values are by weight. The term “polymer” includes “oligomer,” “copolymer,” “terpolymer,” and similar structures. Molecular weights provided for any polymers refer to weight average molecular weight unless otherwise indicated. When a group or class of materials is described as suitable or preferred for a given purpose in connection with the disclosure, it implies that mixtures of any two or more members of the group or class are equally suitable or preferred. Descriptions of constituents in chemical terms refer to the constituents at the time of addition to any specified combination and do not necessarily preclude chemical interactions among the constituents once mixed. The first definition of an acronym or abbreviation applies to all subsequent uses of the same abbreviation and applies mutatis mutandis to normal grammatical variations of the initially defined abbreviation. Unless expressly stated otherwise, the measurement of a property is determined by the same technique as previously or later referenced for the same property.

As used in the specification and the appended claims, the singular forms “a,” “an,” and “the” include plural referents unless the context clearly indicates otherwise. For example, reference to a component in the singular is intended to include a plurality of components. Additionally, this disclosure is not limited to the specific embodiments and methods described herein, as specific components and/or conditions may vary. Furthermore, the terminology used herein is solely for the purpose of describing particular embodiments of the present disclosure and is not intended to be limiting in any way.

The term “comprising” is synonymous with “including,” “having,” “containing,” or “characterized by.” These terms are inclusive and open-ended, meaning they do not exclude additional, unrecited elements or method steps. The phrase “composed of” means “including” or “consisting of” and is typically used to indicate that an object is formed from a specified material.

Integer ranges explicitly include all intervening integers. For example, the integer range 1-10 includes 1, 2, 3, 4, 5, 6, 7, 8, 9, and 10. Similarly, the range 1 to 100 includes all integers from 1 to 100. Additionally, when any range is specified, intervening numbers that are increments of the difference between the upper limit and the lower limit divided by 10 can be considered as alternative upper or lower limits. For example, if the range is 1.1 to 2.1, the numbers 1.2, 1.3, 1.4, 1.5, 1.6, 1.7, 1.8, 1.9, and 2.0 can be selected as alternative lower or upper limits.

Unless explicitly stated otherwise, all numerical values and ranges related to quantities, measurements, percentages, weights, and similar numerical references in this document should be understood as being prefaced by the term “about.” This applies even if “about” is not explicitly mentioned. The intention is that all values and ranges account for variations that may arise from standard measurement techniques, manufacturing processes, material properties, and the intended functionality of the disclosed aspects. For example, when a composition is described as having “5 wt. % of a component,” it should be understood as “about 5 wt. % of a component.” Additionally, when numerical values are given as a range, such as “100 to 200 units,” this range should be interpreted as “about 100 to about 200 units.” These variations are implicitly included within the scope of this disclosure.

The term “positive electrode” refers to a battery cell electrode from which current flows out during the discharge of a lithium-ion battery cell or battery. This electrode is sometimes called a “cathode.” Conversely, the term “negative electrode” refers to a battery cell electrode to which current flows in during the discharge of a lithium-ion battery cell. This electrode is sometimes called an “anode.”

The term “cell” or “battery cell” denotes an electrochemical cell comprising at least one positive electrode, at least one negative electrode, an electrolyte, and a separator membrane. The term “battery” or “battery pack” refers to an electric storage device including at least one battery cell. In a refinement, a “battery” or “battery pack” is an electric storage device composed of multiple battery cells.

The term “specific capacity” refers to the capacity per unit mass of the anode active material, measured in milliamp hours per gram (mAh/g).

As suggested earlier, LMR positive electrode active materials represent a highly promising class of cathode materials for lithium-ion batteries, characterized by their high specific capacity and energy density. These materials are particularly suitable for applications requiring long-range and high-energy, such as electric vehicles and large-scale energy storage systems. A distinguishing feature of LMR materials is their high manganese content, which may make them more attractive compared to cobalt-rich counterparts, due to manganese's relative abundance.

The structure of LMR materials is a composite of layered Lithium (Li) transition metal oxides, which integrates additional Li ions within the lattice. This composite structure may consist of layered LiMO₂ and Li₂MnO₃ components, offering a unique combination of electrochemical properties. LMR materials exhibit high specific capacities, often exceeding 180 mAh/g, due to the reversible redox reactions of both transition metals and lattice oxygen. They may operate at a high voltage, typically up to 4.5Vvs.Gr, contributing to their high energy density. The electrochemical activity of LMR materials involves not only the transition metal redox couples, but also the participation of lattice oxygen, which undergoes reversible redox reactions.

The high capacity and high voltage of LMR materials may result in superior energy density, making them attractive for applications requiring long-range and high-energy batteries. The use of manganese (Mn), a more abundant element than cobalt (Co), further enhances their appeal. Additionally, manganese-based materials may generally offer better thermal stability compared to cobalt-rich materials.

Several challenges, however, need to be addressed for the practical application of LMR materials. One of the issues is voltage fade, a gradual loss of voltage during cycling that leads to a reduction in energy density over time. Structural changes during cycling, including the migration of transition metals and oxygen loss, can affect the long-term cycling stability of LMR materials. Furthermore, LMR materials often exhibit slower kinetics compared to traditional cathode materials, affecting their rate performance. Accordingly, there is a need for LMR material compositions for positive electrode active materials for lithium-ion batteries with increased rate capability, cell performance, and volumetric energy density. The present disclosure provides compositions for LMR cathodes used in lithium-ion batteries.

In one or more embodiments, the LMR compositions have a specific lithium content optimized for performance. The composition is represented by the formula Li_{1.10-a}Mn_{0.52+a}Ni_{0.38-x}CoₓO₂, where 0<a<0.1 and 0≤x≤0.02. This modification aims to increase cycle performance, power performance, and rate capability by increasing voltage stability, and electronic and ionic conductivity of the LMR. The composition maintains a high lithium content (Li_{1.10-a}) to maintain high capacity, while the adjusted ratios of Mn, Ni, and Co aim to maximize structural stability and electrochemical performance. The average oxidation state of Ni is maintained at 2.0, while the average oxidation state of Mn is kept between 3.6 and 4.0, contributing to the overall increase in electrochemical properties and longevity of lithium-ion batteries.

This configuration addresses aspects such as cycle performance, power efficiency, and rate capability. The inclusion of Co and the adjusted ratios of Li, Mn, and Ni aim to increase the battery's durability and efficiency. The composition is designed to maintain the average oxidation states of Mn between 3.6 and 4.0 and Ni at 2.0, contributing to the overall enhancement of electrochemical properties and longevity of lithium-ion batteries. The compound may have a layered crystal structure, such as an α-NaFeO₂-type structure, which may be beneficial for lithium ion intercalation and de-intercalation processes.

For applications requiring higher energy density and increased rate capability, the composition may be fine-tuned within the specified ranges. For instance, adjusting ‘a’ between 0.01 and 0.05, and ‘x’ between 0.005 and 0.015 allows for maximizing the electrochemical characteristics to meet specific performance requirements. These formulations are configured to support longer charge-discharge cycles in demanding conditions. The positive electrode active material may achieve a specific capacity of at least 180 mAh/g. When used in a lithium-ion battery cell, this active material is combined with a negative electrode (often using graphite, silicon, or silicon-carbon composite as the active material) and an electrolyte containing lithium salts such as lithium hexafluorophosphate, lithium tetrafluoroborate, or lithium bis(trifluoromethanesulfonyl)imide in an organic solvent.

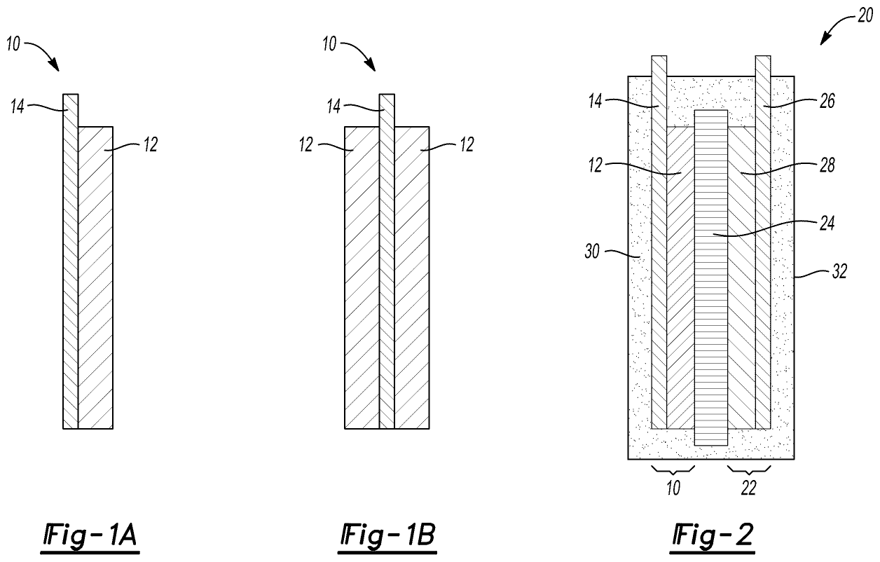

Referring to FIGS. 1A and 1B, a schematic diagram of a positive electrode 10 that includes a positive electrode active material is provided. The positive electrode 10 includes a positive electrode active material layer 12 disposed over and typically contacting a positive electrode current collector 14. Typically, the positive electrode current collector 14 is a metal plate or metal foil composed of metal such as Aluminum (Al), Copper (Cu), Platinum (Pt), Zinc (Zn), Titanium (Ti), and the like. Al is also used for positive electrode current collectors. The positive electrode active material is represented by formula 1:

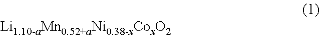

wherein: 0<a<0.1, 0≤x≤0.02, the average oxidation state of the Ni is 2.0, and the average oxidation state of the Mn is between 3.6 and 4.0.

Specific active electrode compositions may be Li_{1.08}Mn_{0.54}Ni_{0.36}Co_{0.02}O₂, Li_{1.08}Mn_{0.54}Ni_{0.37}Co_{0.01}O₂, Li_{1.06}Mn_{0.56}Ni_{0.36}Co_{0.02}O₂, Li_{1.06}Mn_{0.56}Ni_{0.37}Co_{0.01}O₂, Li_{1.04}Mn_{0.58}Ni_{0.36}Co_{0.02}O₂, Li_{1.04}Mn_{0.58}Ni_{0.37}Co_{0.01}O₂, Li_{1.02}Mn_{0.60}Ni_{0.36}Co_{0.02}O₂, and Li_{1.02}Mn_{0.60}Ni_{0.37}Co_{0.01}O₂.

Referring to FIG. 2, a schematic diagram of a rechargeable lithium-ion battery cell 20 is provided. The rechargeable lithium-ion battery cell 20 includes the positive electrode 10 as described above, negative electrode 22, and separator 24 interposed between the positive electrode 10 and the negative electrode 22. The negative electrode 22 includes a negative electrode current collector 26 and a negative active material layer 28 disposed over and typically contacting the negative electrode current collector 26. Typically, the negative electrode current collector 26 is a metal plate or metal foil composed of metal such as Al, Cu, Pt, Zn, Ti, and the like. Currently, Cu is most commonly used for negative electrode current collectors. The rechargeable lithium-ion battery cell 20 is immersed in electrolyte 30 which is enclosed by battery cell case 32. The electrolyte 30 imbibes into the separator 24. In other words, the separator 24 includes the electrolyte 30 thereby allowing Li ions to move between the positive and negative electrodes 10, 22. The electrolyte 30 includes a non-aqueous organic solvent and a Li salt. The non-aqueous organic solvent serves as a medium for transmitting ions taking part in the electrochemical reaction of the rechargeable lithium-ion battery cell 20. Advantageously, the rechargeable lithium-ion battery cell 20 may have a specific capacity of greater than 180 mAh/g.

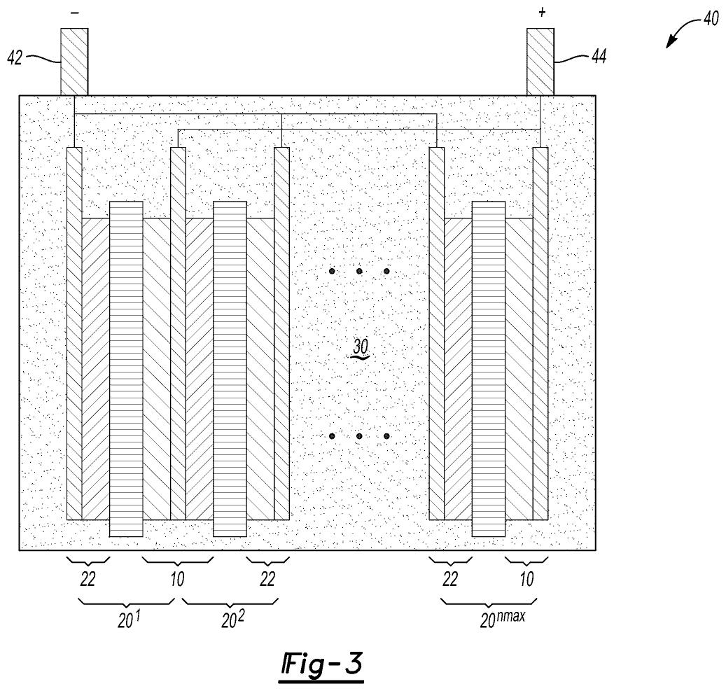

Referring to FIG. 3, a schematic diagram of a rechargeable lithium-ion battery 40 is provided. The battery 40 includes at least one lithium-ion battery cell 20ⁱ of the design of FIG. 2. Each of the lithium-ion battery cells 20ⁱ includes the positive electrode 10 which includes the compound represented by formula 1, the negative electrode 22 which includes a negative active material, and the electrolyte 30, where i is an integer label for each of the lithium-ion battery cells 20i. The label i runs from 1 to nmax, where nmax is the total number of battery cells in the rechargeable lithium-ion battery 40. The electrolyte 30 includes a non-aqueous organic solvent and a Li salt. The non-aqueous organic solvent serves as a medium for transmitting ions taking part in the electrochemical reaction of the battery 40. The battery cells 20ⁱ may be wired in series, in parallel, or a combination thereof. The voltage output from the battery 40 is provided across terminals 42, 44.

Referring to FIGS. 2 and 3, the separator 24 physically separates the negative electrode 22 from the positive electrode 10 thereby preventing shorting while allowing the transport of Li ions for charging and discharging. Therefore, the separator 24 may be composed of any material suitable for this purpose. Examples of suitable materials from which the separator 24 may be composed include but are not limited to, polytetrafluoroethylene (e.g., TEFLON®), glass fiber, polyester, polyethylene, polypropylene, and combinations thereof. The separator 24 may be in the form of either a woven or non-woven fabric. For example, a polyolefin-based polymer separator such as polyethylene and/or polypropylene is typically used for lithium-ion batteries. In order to ensure heat resistance or mechanical strength, a coated separator includes a coating of ceramic, or a polymer material may be used.

The electrolyte 30 includes a Li salt dissolved in a non-aqueous organic solvent as mentioned above. Therefore, the electrolyte 30 includes Li ions that may intercalate into the positive electrode active material during discharge and into the negative electrode active material during charge. Examples of Li salts include but are not limited to LiPF₆, LiBF₄, LiSbF₆, LiAsF₆, LiC₄F₉SO₃, LiClO₄, LiAlO₂, LiAlCl₄, LiCl, LiI, LiB(C₂O₄)₂, and combinations thereof. In a refinement, the electrolyte 30 includes a Li salt in an amount from about 0.1 M to about 2.0 M.

The non-aqueous organic solvent functions as a medium for transmitting ions, particularly Li ions, which participate in the electrochemical reactions within a battery. Suitable non-aqueous organic solvents encompass carbonate-based solvents, ester-based solvents, ether-based solvents, ketone-based solvents, alcohol-based solvents, aprotic solvents, and their combinations. Examples of carbonate-based solvents include, but are not limited to, dimethyl carbonate, diethyl carbonate, dipropyl carbonate, methylpropyl carbonate, ethylpropyl carbonate, methylethyl carbonate, ethylene carbonate, propylene carbonate, butylene carbonate, and their combinations. Ester-based solvents include, but are not limited to, methyl acetate, ethyl acetate, n-propyl acetate, methylpropionate, ethylpropionate, γ-butyrolactone, decanolide, valerolactone, mevalonolactone, caprolactone, and their combinations. Ether-based solvents include, but are not limited to, dibutyl ether, tetraglyme, diglyme, dimethoxyethane, 2-methyltetrahydrofuran, and tetrahydrofuran. Ketone-based solvents may include cyclohexanone. Alcohol-based solvents include, but are not limited to, methanol, ethanol, n-propyl alcohol, and isopropyl alcohol. Aprotic solvents include, but are not limited to, nitriles such as R—CN (where R is a C₂₋₂₀ linear, branched, or cyclic hydrocarbon that may include a double bond, an aromatic ring, or an ether bond), amides such as dimethylformamide, dioxolanes such as 1,3-dioxolane, and sulfolanes.

The non-aqueous organic solvent may be used alone or as a mixture, typically formulated to optimize battery performance. In one refinement, a carbonate-based solvent is prepared by mixing a cyclic carbonate with a linear carbonate. Additionally, the electrolyte may include vinylene carbonate or an ethylene carbonate-based compound to enhance battery cycle life.

Negative and positive electrodes can be fabricated using methods well-known to those skilled in the art of lithium-ion batteries. Typically, an active material (either positive or negative) is mixed with a conductive material and a binder in a solvent such as N-methylpyrrolidone. This mixture forms the active material composition, which is then coated onto a current collector. As the electrode manufacturing method is well-established, detailed descriptions are not provided in this specification. While N-methylpyrrolidone is a commonly used solvent, other solvents may also be suitable for this process.

The positive electrode active material layer 12 comprises the positive electrode active material represented by formula 1, a binder, and a conductive material. The binder enhances the adhesion between the positive electrode active material particles and the positive electrode current collector 14. Suitable binders include, but are not limited to, polyvinyl alcohol, carboxymethyl cellulose, hydroxypropyl cellulose, diacetyl cellulose, polyvinyl chloride, carboxylated polyvinyl chloride, polyvinyl fluoride, ethylene oxide-containing polymers, polyvinylpyrrolidone, polyurethane, polytetrafluoroethylene, polyvinylidene fluoride, polyethylene, polypropylene, styrene-butadiene rubber, acrylate styrene-butadiene rubber, epoxy resin, nylon, and their combinations.

The conductive material provides electrical conductivity to the positive electrode 10. Suitable electrically conductive materials include, but are not limited to, natural graphite, artificial graphite, carbon (C) black, acetylene black, ketjen black, C fibers, Cu, metal powders, and metal fibers. Examples of metal powders and metal fibers include those composed of Ni, Al, silver (Ag), and their combinations.

Referring to FIGS. 1, 2, and 3, the negative active material layer 28 includes a negative active material, a binder, and optionally a conductive material. The negative active materials used herein may be those negative materials known to one skilled in the art of lithium-ion batteries. Negative active materials include but are not limited to, C-based negative active materials, silicon-based (Si-based) negative active materials, and combinations thereof. A suitable C-based negative active material may include graphite and graphene. A suitable Si-based negative active material may include at least one selected from Si, Si oxide, Si oxide coated with conductive C on the surface, and Si coated with conductive C on the surface. For example, Si oxide may be described by the formula SiO_{z} where z is from 0.09 to 1.1. Mixtures of C-based negative active materials or Si-based negative active materials may also be used for the negative active material.

The negative active material layer 28 comprises a negative active material, a binder, and optionally a conductive material. The negative active materials suitable for use in this context are well-known to those skilled in the art of lithium-ion batteries. These materials include, but are not limited to, C-based negative active materials, Si-based negative active materials, and combinations thereof.

The negative electrode binder enhances the adhesion of negative active material particles to each other and to the current collector. The binder may be non-aqueous, aqueous, or a combination of both. Non-aqueous binders include polyvinyl chloride, carboxylated polyvinyl chloride, polyvinyl fluoride, ethylene oxide-containing polymers, polyvinylpyrrolidone, polyurethane, polytetrafluoroethylene, polyvinylidene fluoride, polyethylene, polypropylene, polyamideimide, polyimide, and their combinations. Aqueous binders can be rubber-based or polymer resin-based. Examples of rubber-based binders include styrene-butadiene rubber, acrylated styrene-butadiene rubber, acrylonitrile-butadiene rubber, acrylic rubber, butyl rubber, fluorine rubber, and their combinations. Polymer resin binders include polyethylene, polypropylene, ethylene-propylene copolymer, polyethylene oxide, polyvinylpyrrolidone, epichlorohydrin, polyphosphazene, polyacrylonitrile, polystyrene, ethylene-propylene-diene copolymer, polyvinylpyridine, chlorosulfonated polyethylene, latex, polyester resin, acrylic resin, phenolic resin, epoxy resin, polyvinyl alcohol, and their combinations.

Although exemplary embodiments are described above, they are not intended to represent all possible forms of the disclosure. The language used in the specification is descriptive rather than limiting, and it is understood that various modifications can be made without departing from the spirit and scope of the disclosure. Furthermore, the features of different embodiments may be combined to create additional embodiments of the disclosure.

What is claimed is:

1. A positive electrode active material for lithium-ion batteries comprising a compound represented by a general formula 1: 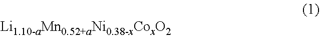
wherein:
0<a<0.1,
0≤x≤0.02,
an average oxidation state of the Ni is 2.0, and
an average oxidation state of the Mn is between 3.6 and 4.0.

2. The positive electrode active material of claim 1 wherein the average oxidation state of the Mn is between 3.6 and 3.96.

3. The positive electrode active material of claim 1 wherein 0.01≤a≤0.09.

4. The positive electrode active material of claim 1 wherein 0.005≤x≤0.02.

5. The positive electrode active material of claim 1 wherein the compound has a layered crystal structure.

6. The positive electrode active material of claim 1 wherein the compound has an α-NaFeO₂-type structure.

7. The positive electrode active material of claim 1 wherein the active material is included in a cathode.

8. A positive electrode, for a lithium-ion battery, including a positive electrode active material comprising a compound represented by chemical formula 1: 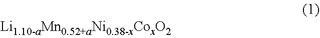
wherein:
0<a<0.1,
0≤x≤0.02,
an average oxidation state of the Ni is 2.0, and
an average oxidation state of the Mn is between 3.6 and 4.0.

9. The positive electrode of claim 8 wherein the average oxidation state of the Mn is between 3.6 and 3.9.

10. The positive electrode of claim 8, further comprising a conductive additive and a binder.

11. The positive electrode of claim 10 wherein the conductive additive comprises carbon black, graphite, carbon nanotubes, or a combination thereof.

12. The positive electrode of claim 10 wherein the binder comprises polyvinylidene fluoride, carboxymethyl cellulose, or a combination thereof.

13. The positive electrode of claim 8 wherein the positive electrode active material has a specific capacity of at least 180 mAh/g.

14. A rechargeable lithium-ion battery comprising at least one lithium-ion battery cell, each lithium-ion battery cell including:
a positive electrode comprising a positive electrode active material as represented by formula 1: 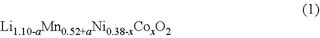
wherein:
0<a<0.1,
0≤x≤0.02,
an average oxidation state of the Ni is 2.0,
an average oxidation state of the Mn is between 3.6 and 4.0;
a negative electrode including a negative active material; and
an electrolyte.

15. The rechargeable lithium-ion battery of claim 14 wherein the negative active material comprises graphite, silicon, silicon-carbon composite, or a combination thereof.

16. The rechargeable lithium-ion battery of claim 14 wherein the electrolyte comprises a lithium salt and an organic solvent.

17. The rechargeable lithium-ion battery of claim 16 wherein the lithium salt is selected from the group consisting of lithium hexafluorophosphate, lithium tetrafluoroborate, lithium perchlorate, lithium hexafluoroarsenate, lithium bis(trifluoromethanesulfonyl)imide, lithium bis(fluorosulfonyl)imide, and combinations thereof.
